(19) United States
(12) Patent Application Publication
(10) Pub. No.: US 2013/0117700 A1
(43) Pub. Date: May 9, 2013

(54) Landscape Delta Path Calculation

(71) Applicants: Andreas Meier, Heidelberg (DE); Tobias Rasch, Wiesloch (DE)

(72) Inventors: Andreas Meier, Heidelberg (DE); Tobias Rasch, Wiesloch (DE)

(21) Appl. No.: 13/293,067

(22) Filed: Nov. 9, 2011

(51) Int. Cl. G06F 3/048

(52) U.S. Cl. 715/771

(57) ABSTRACT

Disclosed are methods, systems and products, including a method that includes generating a system landscape overview of a system landscape including a plurality of systems identified by a unique identifier; placing a system in a location using a context sensitive menu including information to enable placement within the system landscape overview; determining a delta path including one or more instructions to install the placed system in the system landscape; and providing the delta path to enable implementation of the placed system within the system landscape. Related systems, methods, and articles of manufacture are also disclosed.

### BACKGROUND

The present disclosure relates to system representation and, more particularly, to determining a delta path.

Various tools and applications are available to provide a user with at least partial representation of features of a computing system. For example, some tools and applications may be used to illustrate which system ships software to which other. Other tools and applications may be used to display system lifecycle for a certain system or groups of systems. Additionally, various tools and applications may be used to illustrate layers and software components. But, such tools and applications generally do not provide a single comprehensive overview of multiple features of a system.

### SUMMARY

In one aspect, a method is disclosed. The method may include generating a system landscape overview of a system landscape including a plurality of systems identified by a unique identifier; placing a system in a location using a context sensitive menu including information to enable placement within the system landscape overview; determining a delta path including one or more instructions to install the placed system in the system landscape; and providing the delta path to enable implementation of the placed system within the system landscape.

In some implementations, the above-noted aspects may further include additional features described herein including one or more of the following. The landscape generator may generate a hypertext markup language page including metadata representative of the plurality of systems. At least one of a plurality of data repositories may be queried for the metadata including configuration information for the plurality of systems. The context sensitive menu may include selections including whether the system is being placed behind, in front of, or parallel with, another system. The context sensitive menu may be presented within a page depicting the system landscape. Information related to other systems in a transport path within the system landscape may be determined. The information may include at least one release date for the other systems and a required version information for the other systems.

Details of one or more implementations are set forth in the accompanying drawings and in the description below. Further features, aspects, and advantages will become apparent from the description, the drawings, and the claims.

### BRIEF DESCRIPTION OF THE DRAWINGS

FIG. 1A is an example landscape diagram with graphical data representative of features of a computing system;

FIGS. 1B-C are schematic diagrams of an example of a computing system in which the subject matter described herein may be implemented;

FIG. 2A is another example landscape diagram with graphical data representative of features of a computing system;

FIG. 2B is another example of a diagram with graphical data representative of features of a computing system;

FIG. 3 is a flowchart of an example procedure to determine a delta path; and

FIG. 4 is a schematic diagram of an example computing device that may be used in the implementation of any one of the various depicted systems/components/devices described herein.

Like reference numbers and designations in the various drawings indicate like elements.

### DETAILED DESCRIPTION

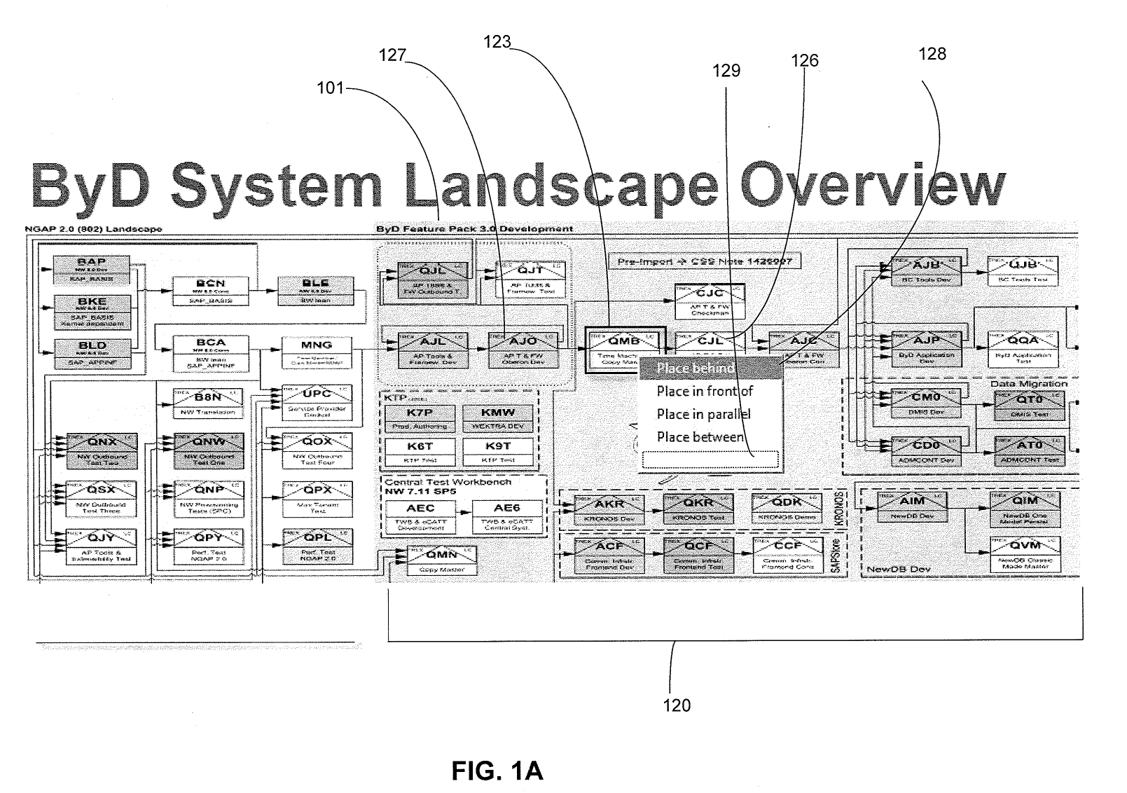

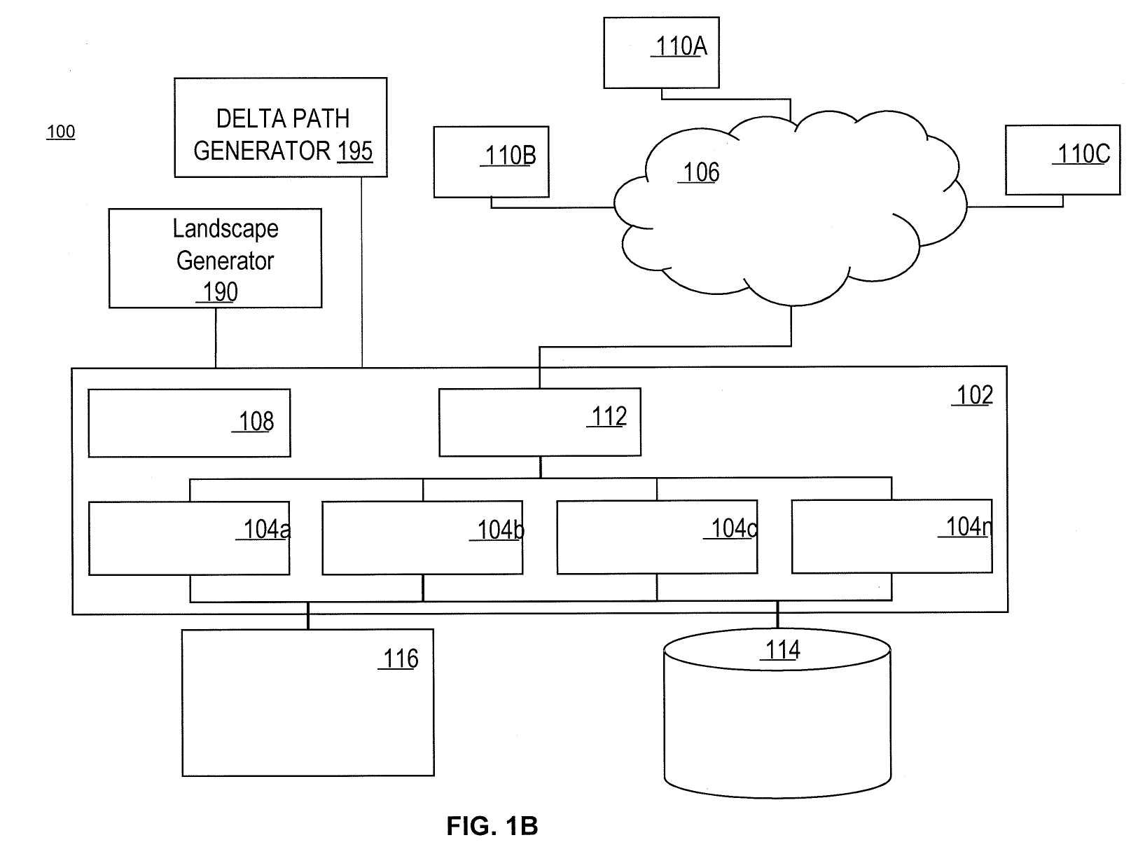

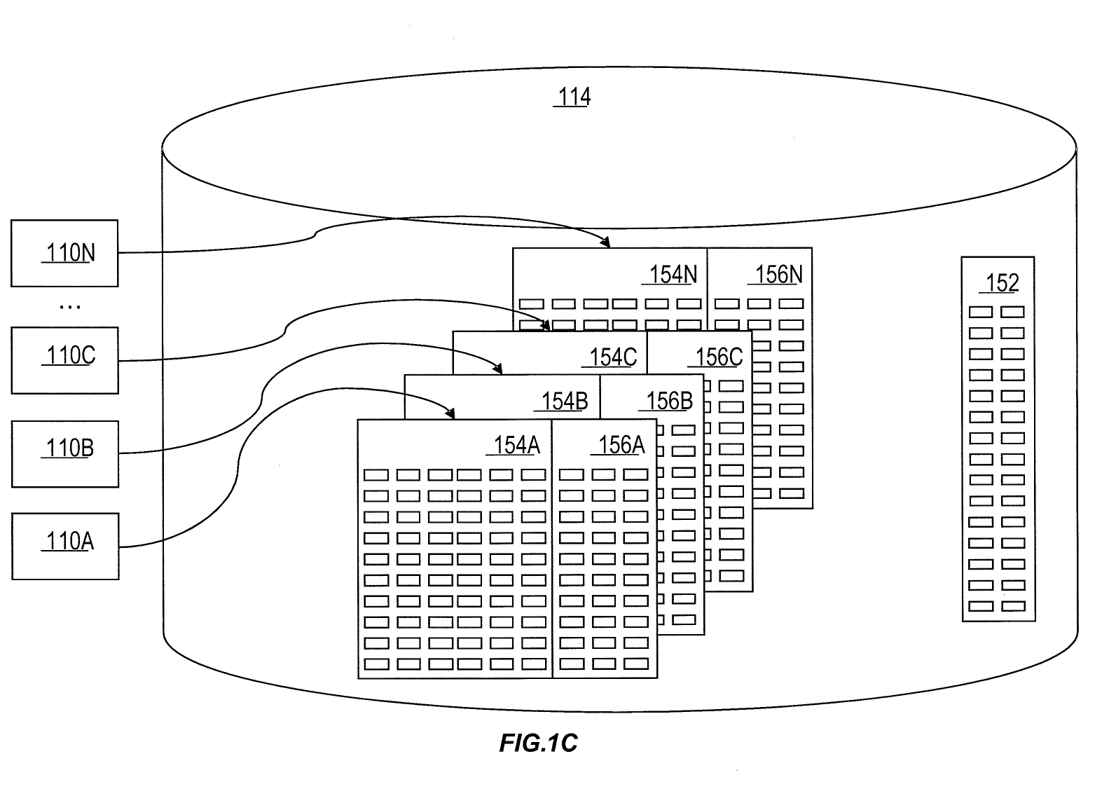

A system landscape may be defined to support the life cycle of an application, such as for example a business application used in connection with enterprise resource planning. The system landscape represents in a graphical manner the interrelationship between systems (also referred to as components, subsystems, and the like) used in the business application. The system landscape may facilitate upgrading or inserting new systems (or moving existing systems) within the business application by allowing a developer to see the impact of the upgrade or insertion on other adjacent systems. Moreover, the system landscape may include transport routes defining how to transport new, upgraded, or relocated data (e.g., software and the like) from one system within the system landscape to another system within the system landscape. An example of a system landscape is depicted at FIG. 1A, which is further described below. During the life cycle of the business application, it might be desirable, or sometimes necessary, to create a new system in the system landscape, to create an upgraded system in the system landscape, or to move an existing system within the system landscape. The data for the creation or move may be packaged as a transport, which may correspond to a portion of software and/or data.

But these created or moved systems might have a different software version level than what is required at a given time to operate with adjacent systems. As such, the changes prompted by the creation or move may prompt the determination of what changes (also referred to as deltas) have to be made to accommodate the move or creation. The determination of the delta prepares a so called delta path which corresponds to an instruction set specifying which piece of software is imported in which sequence into the systems in the system landscape in order to place the created or moved system in a compatible software level to enable proper operation within the system landscape. At best, this calculation may likely result in cumbersome and complex calculation, which is unlikely to be done accurately without an automated process. In any case, a so-called delta path is determined.

Although there are tools to show the graphical representation of the assigned systems of a business application including the releases and layers and the software flow oriented chain of systems (see, e.g., U.S. application Ser. No. 12/979,923, filed Dec. 28, 2011, entitled “System Landscape Overview Generator,” Attorney Docket No. 34874-517F01 US, which is incorporated by reference in its entirety herein), there is no mechanism to extract the software level from systems within a system landscape overview and then calculate the required delta path to place a system at a software level of other systems as a prerequisite to the creation and/or move of the system into a transport route defined in the system landscape.

The subject matter described herein thus relates to, in some implementations, entering an identifier, such as a system identifier, of a new system, such as a newly created, upgraded system, and/or moved system, and then indicating the planned location in the system landscape overview presented at the user interface. For example, the new system to be added or moved may be dragged and dropped on the system landscape overview page to the planned location within the system landscape.

Moreover, a context sensitive menu may also be provided within the context of the system landscape overview generator. The context sensitive menu may allow specifying details regarding the system being created or moved. For example, the context sensitive menu may provide options, such as place added system in parallel to existing system abc, place added system behind existing system abc, and the like.

Based on the placement and context of the created or moved system, the delta path generator may determine information about the software level for the created or moved system as well as other systems in the system landscape. Using this information about the software level of the systems enriched with information from a rules store (e.g., rules defining how to handle creations and moves within the system landscape) the delta path generator may then determine the required delta path in order to create or move the new system while maintaining compatibility among the software of the systems in the system landscape. For example, the delta path generator may determine for a system landscape the following delta path may be implemented to ensure a compatibility after the move or creation of the system: (1) import NW-Upgrade abc to klm in one queue; (2) next, import NW-Upgrade xyz, (3) next, import transport 123 to 456; and (4) done.

FIG. 1A represents an example of a system landscape overview 101 including a context sensitive menu 128. Each system in the system landscape overview is identified with an identifier, which in the example at FIG. 1A includes 3-letters, although other types of identifiers may be used. Each identifier may be mapped to metadata describing the code being used at the system, the release data of the code, and the like to enable determining the compatibility of system software versions. Moreover, the system landscape overview 101 may depict the transport relationships between systems and information, such as the identity of systems (or software components) that are part of the system landscape, whether any system (or software component) is being developed in the system landscape, and whether any transports (e.g., including systems, software components, data, etc.) have been imported into, or from, the system landscape. In the example of FIG. 1A, the system landscape overview 101 depicts a plurality of systems, such as BAP, BKE, BLD, and so forth. The system landscape overview also depicts that the systems in 120 are under development and that the transport of system QMB 123 is being implemented. A source system may be selected, dragged, and dropped into another, target system or a transport route as well. Next, a context sensitive menu pops up to provide information (e.g., where to place source system relatively to chosen target system, such as behind, in front, etc.).

With respect to the import of system QMB 123, system QMB 123 is being placed behind system CJL 126 in the system landscape overview 101. A context sensitive menu 128 is also presented on top of, or adjacent to, the system landscape overview 101 presented at a user interface. Moreover, the context sensitive menu 128 allows selection of whether QMB 123 should be place behind, in front of, in parallel with, or between, a system CJL, which is identified at 129 (e.g., by typing in at 129 the identifier CJL 126). The location of QMB 123 in the system landscape at a given time allows a determination of the current code levels (also referred to as versions) of the systems by retrieving such metadata information from a repository, and then a determination of the necessary actions to maintain compatibility (e.g., by transporting software and data to one or more other, adjacent systems within the system landscape).

FIG. 1B shows a block diagram of a multi-tenant implementation of a software delivery architecture including a landscape generator 190 and a delta path generator 195, although the landscape generator 190 and a delta path generator 195 may be implemented in other types of implementations as well.

The system 100 may include an application server 102, which can, in some implementations, include multiple server systems 104a-n that are accessible over a network 106 from client machines operated by users at each of multiple organizations 110A-110C (referred to herein as “tenants” of a multi-tenant system and/or as “clients”) supported by the system 100. Additional or fewer clients may be in communication with the server 102 via the network 106. Each of the clients 110A-C may constitute at least part of a local server serving at least one of a plurality of entities. Such entities can include different companies that may or may not be related to one another, or may include any type of user that can access any one of the servers 104a-n. The one or more clients 110A-C are configured to enable users to provide input and receive data (displayable, for example, via local interfaces coupled to the respective clients 110A-C). The one or more clients 110A-C communicate with the one or more application servers 104a-n via, for example, direct wire-based links, network communication links, wireless communication links, etc.

For a system in which the application server 102 includes multiple server systems 104, the application server can include, in some embodiments, a load balancer 112 to distribute requests and actions from users at the one or more clients 110A-110C to the one or more server systems 104. A user can access the software delivery architecture across the network using a thin client, such as for example a web browser or the like, or other portal software running on a client machine. The application server 102 can access data and data objects stored in one or more data repositories 114. The application server 102 can also serve as a middleware component via which access is provided to one or more external software components 116 that can be provided by third party developers.

The servers of the application server 102 may each execute a set of services (also referred to as “application services”) that process/serve users' requests. For example, a user, interacting with the application server 102 through, for example, one of the interfaces of the clients 110A-C, can submit a request for service by one or more of the applications on the one or more servers of the application server 102, that cause one or more instances of the applications required to serve the request to be invoked. In some embodiments, the application server system 102 may include systems/components/modules, such as, for example, a message server to enable communication between the individual servers and/or between the application server 102 and other application servers (e.g., transmitting requests and data from one application server to another and responding to requests for information to enable generation of a landscape overview directory and the like). In some implementations, a message server may monitor and manage information about the application servers and/or their respective servers, e.g., information such as current request loads and data traffic supported by the various servers.

To provide for customization of the core software platform for each of multiple organizations/entities supported by the system 100, the data and data objects stored in the repository or repositories 114 that are accessed by the application server 102. In some embodiments, the repository 114 may be implemented using, for example, a database system that generally includes a data management application (which may be executing locally or remotely) and one or more data storage devices (i.e., memory devices, which may be distributed over a network), in which data relating to the objects to be managed is maintained. The data management application may be a commercial or customized data management system, e.g., a database management application implemented in software and executing on processor-based servers. Microsoft SQL server is an example of a commercially available database management application. The database system may also include a communications module to enable it to communicate with remote devices (e.g., wirelessly, through a network gateway connection, or through wired links). In some implementations, a database interface may include a buffer, or cache, to store frequently accessed data in the local memory of the application server.

Data stored in the repository 114 may include, in some embodiments, three types of content as shown in FIG. 1C: core software platform content 152, system content 154, and tenant content 156. Core software platform content 152 includes content that represents core functionality and is not modifiable by a tenant. System content 154 can in some examples be created by the runtime of the core software platform and can include core data objects that are modifiable with data provided by each tenant. For example, if the core software platform is a business system, such as an enterprise resource planning (ERP) system that includes inventory tracking functionality, the system content 154A-154N can include data objects for labeling and quantifying inventory. The data retained in these data objects may be tenant-specific: for example, each tenant (e.g., a client) 110A-110C stores information about its own inventory, which might be kept private (i.e., inaccessible to other clients unless authorized by the tenant). Tenant content 156A-156N includes data objects or extensions to other data objects that are customized for one specific tenant 110A-110C to reflect business processes and data that are specific to that specific tenant and are accessible only to authorized users at the corresponding tenant. Such data objects can include a key field (for example “client” in the case of inventory tracking) as well as one or more of master data, business configuration information, transaction data or the like. For example, tenant content 156 can include condition records in generated condition tables, access sequences, price calculation results, or any other tenant-specific values. A combination of the software platform content 152 and system content 154 and tenant content 156 of a specific tenant are presented to users from that tenant such that each tenant is provided access to a customized solution whose data are available only to users from that tenant.

A multi-tenant system such as that described herein may include one or more of support for multiple versions of the core software and backwards compatibility with older versions, stateless operation in which no user data or business data are retained at the thin client, and no need for tenant configuration on the central system. As noted above, in some implementations, support for multiple tenants can be provided using an application server 102 that includes multiple server systems 104a-n that handle processing loads distributed by a load balancer 112. Potential benefits from such an arrangement can include, but are not limited to, high and reliably continuous application server availability and minimization of unplanned downtime, phased updating of the multiple server systems 104 to permit continuous availability (one server system 104 can be taken offline while the other systems continue to provide services via the load balancer 112), scalability via addition or removal of a server system 104 that is accessed via the load balancer 112, and de-coupled lifecycle processes (such as for example system maintenance, software upgrades, etc.) that enable updating of the core software independently of tenant-specific customizations implemented by individual tenants.

In some embodiments, at least some of the clients 110A-C and/or the servers 104a-n of the application server 102 may be implemented based on a cloud-based system, such as SAP's By Design system. A cloud-based system generally enables a user at, for example, the client 110A to access core/central system resources on-demand. These core/central resources comprise business software-based systems hosted at a remote location in the cloud, e.g., accessed via the Internet. The cloud-based system may include a heterogeneous system of different subsystems providing a management system for managing financials, customer relationships, human resources, projects, procurement, and/or a supply chain. The cloud-based system may include a “central component(s)” located remotely in the so-called cloud. These central components are shared, for example, by tenants, such as ABAP (Advanced Business Application Programming) client applications. For example, the clients 110A-B may be located at one or more user locations, but the application server 102 including the repository 114 may be accessed as a service on-demand via a cloud. Although ByDesign and cloud based software-as-a-service systems are noted herein, the subject matter described herein may be used in other systems as well.

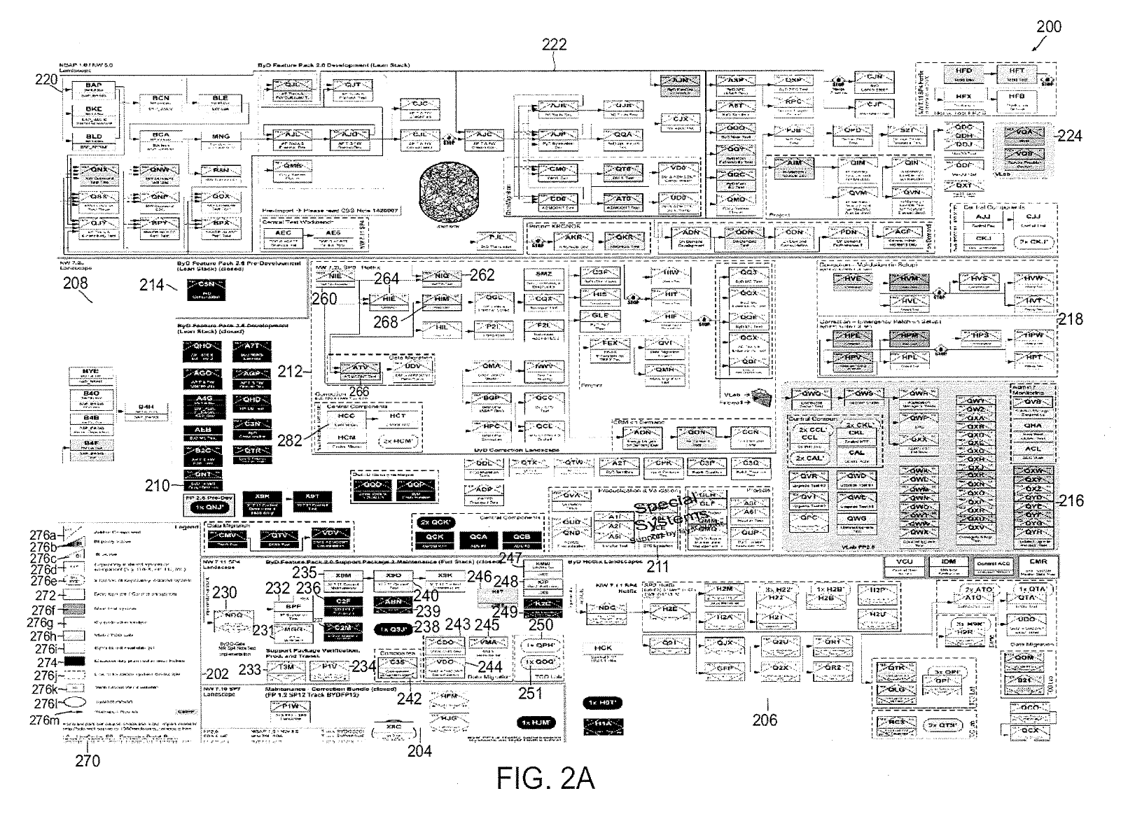

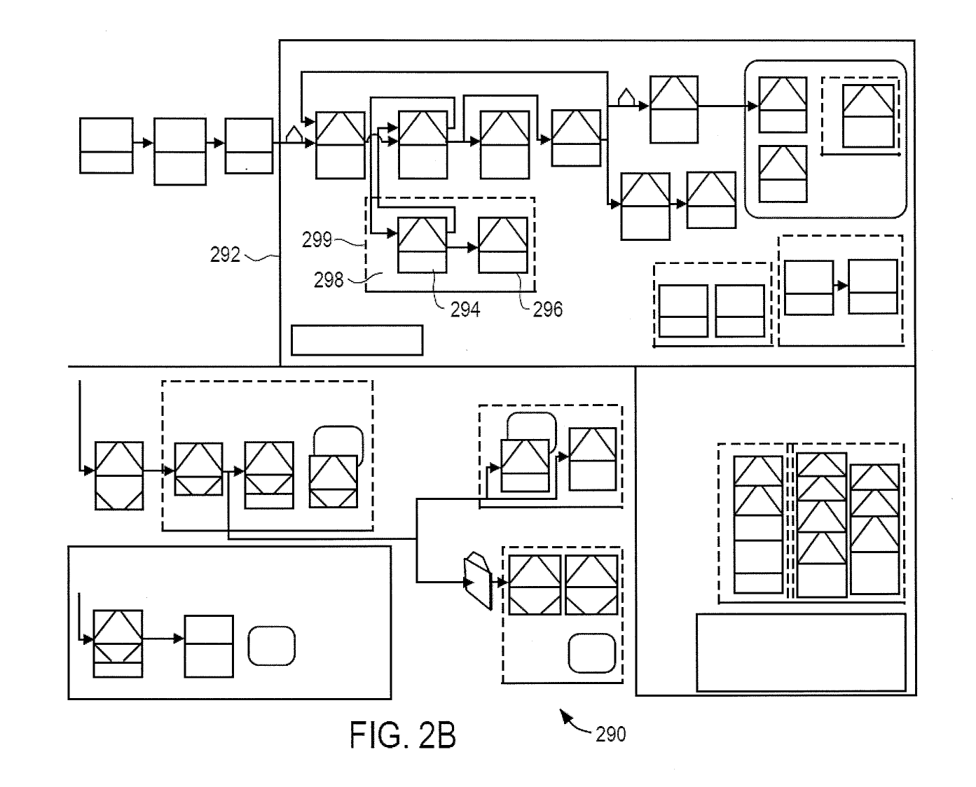

System 100 may, as noted, further include a landscape generator 190 and a delta path generator 195. The landscape generator 190 may be configured to collect/receive data relating to features of a computing system (which may be the computing system 100, a portion of the system 100, or some other computing system), and further configured to generate a diagram, based on the collected/received data, representative of the features of the system with respect to which the data was collected/received. Examples of the pages depicting the system landscapes generated by landscape generator 190 are shown at FIGS. 1A, 2A, and 2B. The delta path generator 195 may determine a delta path including the instructions for moving a created or moved system within a system landscape. The delta path generator 195 may also generate the context sensitive menu, gather based on system identifiers information for systems in the landscape, and perform other operations described herein.

With reference to FIG. 2A, an example system landscape overview page 200 is depicted. The system landscape overview page 200 may represent all of the systems associated with a business application. Moreover, the system landscape overview page 200 may, in some implementations, be generated by landscape generator 190 based on system information stored in a repository, and then the generated page (e.g., a hypertext markup language page) is presented at a user interface.

The diagram 200 shown in FIG. 2A provides a representation of several systems (which may also be referred to herein as subsystems), such as subsystems 202-224. Each such subsystem may be an application, a system comprising several applications, or may otherwise represent any abstraction of a computing arrangement at any hierarchical level of system or network arrangement. Each of the subsystems represented in the diagram may provide a representation of at least some of the individual processing components (e.g., modules constituting an application). For example, the subsystem 202 comprises processing components 230-251. The area of the diagram depicting the subsystem 202 provides a graphical representation of the configuration/arrangement of the components constituting that subsystem, including data flow between various individual components of the subsystem. The example diagram 290 of FIG. 2B provides another example landscape representation of a system, including at least some of the system's subsystems (and their components), the interrelationships between the subsystems and/or the components, etc.

The landscape diagrams described herein, including, for example, the example diagram 200, include graphical representations of at least some of the features of the system in question, including, for example, a graphical representation of an order of release of at least some of the subsystems constituting the system and layered relationship information, e.g., layered relationships between various subsystems of the computing system. More particularly, in some implementations, the vertical positioning of subsystem representations (e.g., the respective blocks representative of the subsystems) may be used to represent the order of release, and can thus provide a representation of the development history (or evolution) of the subsystems. In the example of FIG. 2A, the subsystem 220, identified as NGAP 1/NW 8.0 (i.e., release 8.0 of the NetWeaver application, which is a platform that provides development and runtime environment for SAP applications and can be used for custom development and integration with other applications and systems), is positioned at a higher vertical position than the block representing the subsystem 208, which is identified as NW 7.2L (i.e., NetWeaver release 7.2L), indicating that the components (and other represented features, including the inter-component configuration of the subsystem 222) were released (or rolled-out) subsequent to the subsystem components, and other features, depicted in the block representing the subsystem 208. Similarly, the subsystem 208 depicting at least part of the subsystem features for NetWeaver, Release 7.2L, is located at a higher vertical positioning in the diagram 200 than the block 202 which depicts features corresponding to NetWeaver, Release 7.11. Thus, the vertical positioning of blocks provides an easy visual tool for a user to identify the order of release of various aspects of the subsystems depicted in the diagram.

In some implementation, the representation of the order of release of one or more subsystems may be used to indicate the constituents/components of the subsystems (and their configuration) at various release date. That is, in some embodiments, instead of representing the entire subsystem in a single block, the subsystem configuration may be divided into several blocks that each corresponds to a different release date for that subsystem. Under such circumstances, a portion of the subsystem released at a particular date will occupy a different block (in the landscape diagram) than portions of the subsystem released at different dates. Such a representation enable breaking the subsystem representation into more manageable multiple blocks that also convey to the user important information on the evolution of the subsystem in question (e.g., when was a particular functionality of the subsystem, implemented using the components depicted in a block, released).

Another feature that may be represented in a diagram, such as the diagram 200, is the layered relationship between various subsystems, including, for example, data flows between the subsystem, hierarchical relationships between the subsystems constituting the layers of the system represented by the diagram, etc. In some implementations, system layer information is provided, for example, through the horizontal positioning of the subsystem representations (e.g., blocks) in the diagram. In the diagram 200, the layered relationship between blocks 212 and 216 can be represented by the horizontal positioning of the blocks. In the embodiments of FIG. 2A, blocks located farther along the horizontal axis (the x-axis) indicate that their corresponding subsystems are at a higher layered relationship compared to blocks that are closer to the origin of the horizontal axis (i.e., farther to the left). For example, as shown in FIG. 2A, the subsystem depicted in block 212 provides input to the subsystem of block 216 (labeled VLab FP2.6), which is located farther along the horizontal axis than does block 212, thus indicating that the subsystem of block 216 is at a higher layered relationship compared to the subsystem represented by Block 212. Accordingly, the diagram 200 provides an easy-to-understand visual tool to identify the layered relationship of the subsystems depicted in the diagram.

Features of the system relating to data flows of individual components (e.g., modules) of the subsystem may also be represented. As illustrated, the configuration of the subsystem 212 includes data flows between individual components of the subsystem 212. For example, the processing component 260 of the subsystem 212 is in communication with the components 262, 264, and 266, and provides them with data and/or instructions/commands. Processing block 264, in turn, is also in communication with processing blocks 268 and provides that block with input (e.g., data and/or instructions/commands). The input/output flows of the subsystem 222, as well as other subsystems depicted in the diagram 200, thus provides an easy-to-understand representation of interrelations of the various components of the subsystems (e.g., configuration and data flows), as well as the interrelationships between the subsystems themselves. The diagram 200 illustrates the data flow information using directional arrows (e.g., an arrow going into a particular component or into a subsystem represents input into that subsystem, and similarly, directional arrows flowing out of components and subsystems represent output flows). Other ways to represent communication paths and flows within the system are also possible.

In some implementations, the generated system diagram may include additional information representative of further features of the system, its subsystems, and/or the subsystems' components. For example, and as shown in FIG. 2A, the diagram 200 may include text-based data representative of at least one of, for example, identity of the system/subsystems/components (e.g., their names or codes identifying the various parts of the system), developmental status for at least one of the subsystems, usage for at least one of the subsystems of the computing system, number of installed layers, etc. Information regarding the above features (identity, status, etc.) may also be provided through color codes, fill-patterns used to fill the various objects appearing in the diagram, the particular shape of the objects, etc. For example, as shown, the diagram 200 includes, with respect to the subsystem 220, the subsystem identity (which may be an abbreviation, acronym or code) of “NGAP 1.0/NW 8.0 Landscape,” as well as release number (as noted above, order of release information is also conveyed by the relative vertical positioning of subsystems' blocks relative to other blocks). Text-based data may also be used to annotate the diagram and provide additional useful information. For example, the subsystem 211 (appearing within the subsystem 210) includes the annotations “Productization and Validation” and “Special System” to provide some information about the role and nature of the subsystem depicted in the block.

Color-code data, fill-pattern data, and pre-defined geometrical shapes may be used to further represent data regarding features of a computing system, its subsystems, and of the subsystems' components. As shown, FIG. 2A includes a legend 270 defining various shapes, color, and/or fill-patterns representative of various aspects/features of the system represented by the diagram 200. For example, the legend 270 defines the square-shaped symbol 272 with its associated illustrated fill-pattern (and which may also include a pre-defined color) as being representative of development/correction components. Thus, components appearing in the diagram 200 that have the geometric shape (square) and fill pattern of the symbol 272 correspond to components/modules/subsystems that, for example, are under development. In the example of FIG. 2A, the component 235 in the subsystem 202 (identified as “X9M”) and component 282 in the subsystem 212 (identified as “HCC”) are two components that are indicated to be under development. As another example, the legend also includes the square-shaped symbol code 274 having a dark fill-in pattern, that corresponds to components (e.g., modules) that are planned for disassembly (e.g., to be discontinued). In the example of FIG. 2A, the component 236 in the subsystem 202 (identifies as “C2F”) and the component 237 in the subsystem 202 (identified as “C2M”) are two components that are represented, using easy-to-understand graphical/visual representation, as components that have been designated to be disassembled at some point in the future.

Additional representations based on pre-defined color, pre-defined fill-patterns, and pre-defined geometric shapes include symbol codes 276a-m shown in the legend 270, which include, respectively, a symbol code 276a to represent an add-in component (represented as a blank right-angle triangle), symbols codes to represent active or partly active components (symbols 276b-c), a symbol 276d to represent a separately installed system or component, a symbol code 276e to represent a clone of a separately installed system or component, a symbol code 276f to represent a main system test, a symbol code 276g to represent a consolidation system (or component), a symbol code 276h to represent subsystems/systems set up in a customer like way (such systems are sometimes referred to as “TCO Lab,” or “Systems of Verification lab”; these systems may also be represented with a special color to indicate that these systems are separated on a network level from a development network), a symbol code 276i to represent that the corresponding system/subsystem/component is not yet available, a symbol code 276j to, in some embodiments, represent a link to a separate landscape, and in some embodiments, to represent a system with special focus (e.g., like the frame 299 of FIG. 2B), a symbol code 276k that, in some embodiments, indicates that a web dispatcher is available (in some implementations, SAP's WebDispatcher may be used to access all the systems and thus the symbol 276k may not be needed), a symbol code 2761 (e.g., an ellipse) indicating that the corresponding system/subsystem/component has moved, and an arrow symbol code 276m representative of a transport route (e.g., to represent data flow paths). Fewer or additional symbol codes, each represented by a pre-defined color(s), a pre-defined geometric shape, and/or a pre-defined fill-pattern, may be used in conjunction with the legend 270, and by extension, in conjunction with the landscape diagram (such as the diagram 200).

Thus, in some embodiments, at least some processing components of at least one of the subsystems of the computing system are represented as a square icons, with each of the square icons including at least one of, for example, color-based information representative of data processing equipment type for an associated data processing component, color based information representative of the developmental status of the associated data processing component, a component name of the associated data processing component, a description of the associated data processing component, structure information for the associated data processing component, and information regarding the use/purpose for the associated data processing component.

Additionally, features of a given computing system, or of multiple inter-connected, computing systems, may be represented using other types of representation schemes.

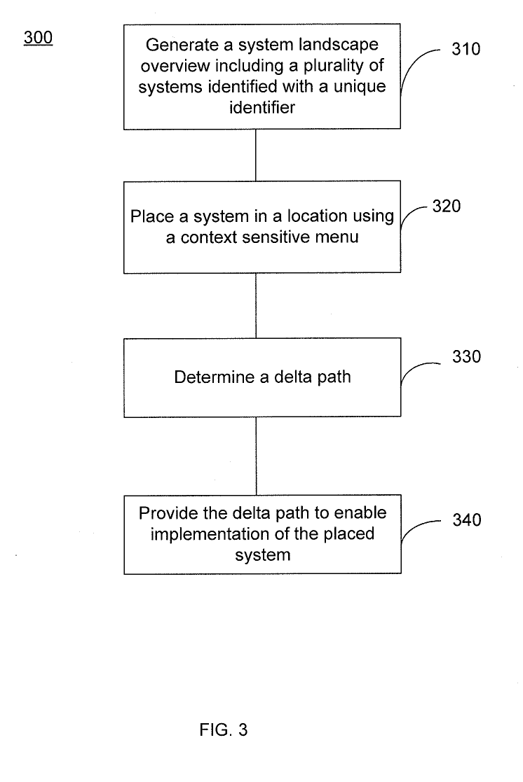

FIG. 3 depicts a process 300 for determining a delta path.

At 310, a landscape overview is generated. For example, a system landscape overview, such as those depicted at FIGS. 1A, 2A, and 2B may be generated by the landscape generator 190. In some implementations, to generate such a diagram, data relating to features of the system is received (retrieved) at, for example, an application configured to generate a landscape diagram representative of such received data. The data from which data can be used may be collected automatically by, for example, having a data collection application, such as landscape generator 190 shown in FIG. 1B, query data repositories holding configuration information in relation to the system(s) whose features are to be represented. For example, in some implementations, queries may be sent to an interface used to access and manage configuration data, including landscape data, maintained for various systems (e.g., systems implemented using the computing system 100).

In some embodiments, system configuration and/or landscape data may be maintained, at least in part, in a landscape directory (which may be stored, in some embodiments, at a data repository (e.g., such as the data repository 114 shown in FIG. 1B) of the computing system 100). Such landscape data may be arranged in data records that are stored in clients' (tenants) individual landscapes. Further details regarding implementations and use of landscape directories, including landscape directories to manage systems implemented using cloud computing, are provided, for example, in U.S. application Ser. No. 12/953,300, entitled “Cloud-Processing Management With A Landscape Directory,” the content of which is hereby incorporated by reference in its entirety. Briefly, a landscape directory may be used to enable automatic connection of pre-defined and pre-developed components (e.g., components that include other applications and tools) of systems/subsystems, including customer-specific systems, on-demand systems, etc. Such system management functionality may be implemented, at least in part, through use of a bundle of interfaces to provide clients access to the clients' shared and private landscape data in the landscape directory.

Landscape data at a landscape directory may also include data that defines the connectivity between various applications, and may define separate connectivity configurations for the various clients/tenants that use identified applications. A landscape directory may also be used to maintain access data pertaining to the accessibility of applications to be used by the various clients, and may include, for example, status and availability information for the various applications, e.g., whether service applications are active, information as to whether downtime is scheduled for any application, lifecycle status information (e.g., for a particular application, whether the application has been released, is obsolete, has been replaced by another application, etc.), and other such information. The data recorded in a landscape directory may thus be used to automatically determine, for example, communications paths and links between interacting subsystems (applications) identified in a particular landscape. Thus, in some embodiment, the data based on which diagrams may be generated may be received/collected from a landscape directory maintaining landscape data for multiple tenants with access to a computing system.

In some implementations, collection of configuration data (for the purpose of generating a diagram representative of various system features) may be performed by contacting various monitoring tools/applications, such as monitoring tool 108, deployed in the system 100 of FIG. 1B. When the system whose representation is to be rendered is implemented, at least in part, using cloud computing, similar monitoring tools/applications may be deployed with the cloud computing. The various deployed monitoring tools/applications may be configured to perform tests/diagnostics on some or all of the subsystems (e.g., applications) constituting the system to be represented, to determine, for example, the applications' status and availability. Examples of suitable monitoring tools/applications include tools based on SMD/Wily monitoring technology (SMD is SAP's Solution Manager Diagnostics tool for monitoring large scale installations), and other types of health checks and monitoring tools. A description of some possible monitoring tools and arrangements that may be used is provided, for example, in application Ser. No. 12/624,279, entitled “SYSTEM MONITORING,” the content of which is hereby incorporated by reference in its entirety.

After receiving/collecting data relating to features of the computing system, a diagram that includes data (e.g., graphical data) representative of, at least partly, the features of the computing system may be generated. The data included in the generated diagram (e.g., landscape diagram) includes data representative of, at least, an order of release of at least some of subsystems of the computing system, and layered relationship information, such as information about the layered relationships between various of the subsystems of the computing system. In some implementations, the landscape diagram may include text-based data, color-based date, pre-defined geometrical shapes representative of some features, and/or pre-define fill-pattern data representative of some other features.

Generation of the diagram based on the previously received data pertaining to system features may be performed automatically by, for example, an application such as the landscape generator 190 depicted in FIG. 1B, using the data to determine, for example, positions in the diagram, as well as the symbols' colors and geometric shapes that are to be rendered in the diagram. For example, components of a subsystem determined to be associated with a recent release of a particular subsystem would be positioned at a high vertical position relative to earlier releases of other components of the particular subsystem.

The determined data (e.g., position, colors, patterns, shapes, text-based information, etc.) is then generated into a page, such as a hypertext transfer language page, and rendered in the diagram presented at a user interface. Additionally and/or alternatively, in some embodiments, custom-made diagram-generating applications may be developed and used to generate diagrams such as the system landscape overview diagrams depicted at FIGS. 1A, 2A, and 2B.

The generated diagram may then be provided to a user interface for presentation. Such a user interface may be a user interface implemented at a server of a client (e.g., such as any of the clients 110A-C depicted in FIG. 1B).

Referring again to FIG. 3, at 320, a context sensitive menu is placed within the system landscape. For example, delta path generator 195 may generate a context sensitive menu, such as menu 128 and place menu 128 within, or adjacent to, system landscape overview 101 to allow placement of a system being imported (e.g., created or moved) into the system landscape depicted at, for example, FIG. 1A. In the example of FIG. 1A, system QMB 123 is placed behind system CJL 126 in the system landscape overview 101 based on the selections made at the context sensitive menu 128. For example, the context sensitive menu 128 may be used to select whether the system is being placed behind, in front of, in parallel with, or between, a system CJL, which is identified by typing in at 129 the identifier CJL.

At 330, the delta path generator 195 determines a delta path. For example, the delta path generator 195 may determine information related to the other systems in the transport path of system 123 which was placed in the system landscape 101. This information may include the release date and required software versions for a system 127 and system 126 which are in the transport path. Given this information as well as other information (e.g., the requirements of each system in the system landscape, rules, tables listing the compatibility of different versions of different systems, and the like), the delta path generator 195 may determine what changes have to be made to the systems to maintain compatibility. These changes may take the form of a delta path including one or more instructions. For example, the delta path generator 195 may determine the required delta path in order to place system 123 while maintaining compatibility. In this example, the delta path generator 195 may determine that at a given the current system landscape 101 the following delta path may be implemented to ensure a smooth implementation of the upgrade: (1) import upgrade 1.0 at system 127; (2) next, import upgrade B at system 126, (3) next, import transport 123 behind system 126, and (4) done.

At 340, the delta path generator may provide the determined delta path to allow the implementation of the system being placed. Returning to the previous example, the delta path generator 195 may provide the delta path (e.g., (1) import upgrade 1.0 at system 127; (2) next, import upgrade B at system 126, (3) next, import transport 123 behind system 126, and (4) done) to another entity for execution.

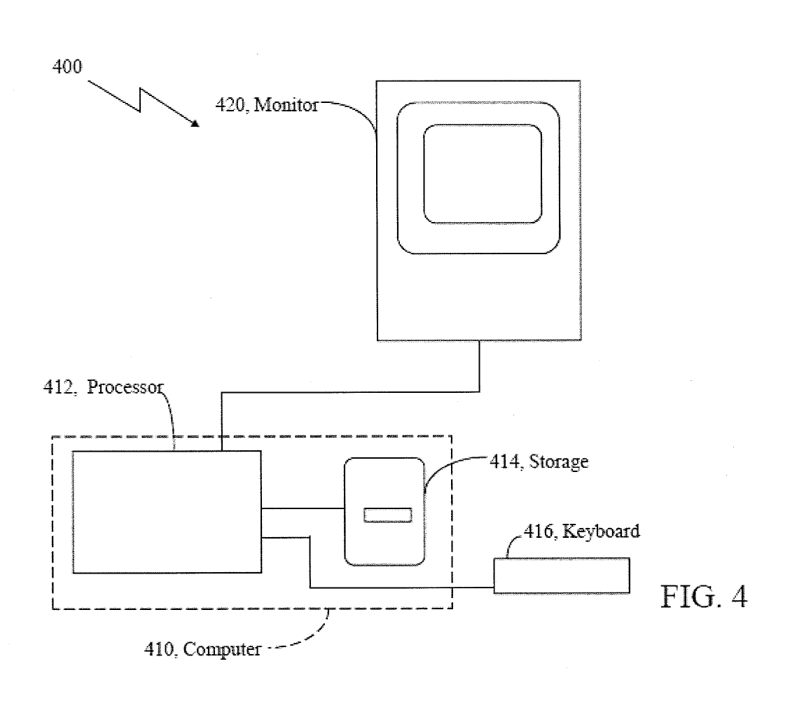

Each of the various systems/components/devices depicted in FIG. 1B may be implemented using a processor-based computing device. Referring to FIG. 4, a schematic diagram of a computing system 400 that may be used in the implementation of any one of the various depicted systems/components/devices described herein. The computing system 400 includes a processor-based device 410 such as a desktop or laptop computer, wireless device, a personal computer, a personal digital assistant, a smart phone, a tablet computer, a specialized computing device, a reading machine, and so forth, that typically include a central processor unit 412. In addition to the central processor unit 412, the system includes one or more of the following: main memory, cache memory, bus interface circuits, network interfaces (e.g., wireless and/wired), and a location processor. The processor-based device 410 may also include a mass storage element 414. The computing system 400 may further include an input device, such as a keyboard 416, and a display 420, e.g., a LCD (liquid crystal display) monitor.

The processor-based device 410 is configured to perform some or all of the operations described herein, including operations to collect and receive data relating to features of a computing system, and to generate, based on the received data, a diagram that includes graphical data representative of the system's features. The storage device 414 may include computer program products that when executed on the processor-based device 410 cause at least some of the operations for receiving data relating to system features and generating a diagram based, at least in part, on that data, generating a context sensitive menu, determining a delta path, and providing the delta path to another entity for implementation.

The processor-based device may further include peripheral devices to enable input/output functionality. Such peripheral devices include, for example, a DVD drive or a network connection, for downloading related content to the connected system. Such peripheral devices may also be used for downloading software containing computer instructions to enable general operation of the respective system/device, and for downloading software implemented programs to perform operations pertaining to the procedures and operations described herein. Alternatively and/or additionally, in some implementations, special purpose logic circuitry, e.g., an FPGA (field programmable gate array) or an ASIC (application-specific integrated circuit) may be used in the implementation of the system 400.

Other modules that may be included with the processor-based device 410 are speakers, a sound card, a pointing device, e.g., a mouse, a trackball, and/or a stylus, by which the user can provide input to the computing system 400. Other kinds of devices can be used to provide for interaction with a user. For example, feedback provided to the user can be any form of sensory feedback, e.g., visual feedback, auditory feedback, or tactile feedback, and input from the user can be received in any form, including acoustic, speech, tactile input, etc. The processor-based device 410 may include an operating system.

The subject matter described herein can be implemented in digital electronic circuitry, in computer software, firmware, hardware, or in combinations of them. The subject matter described herein can be implemented as one or more computer program products, i.e., one or more computer programs tangibly embodied in non-transitory media, e.g., in a machine-readable storage device, for execution by, or to control the operation of, data processing apparatus, e.g., a programmable processor, a computer, or multiple computers. A computer program (also known as a program, software, software application, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file. A program can be stored in a portion of a file that holds other programs or data, in a single file dedicated to the program in question, or in multiple coordinated files (e.g., files that store one or more modules, sub-programs, or portions of code). A computer program can be deployed to be executed on one computer or on multiple computers at one site or distributed across multiple sites and interconnected by a communication network.

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Media suitable for embodying computer program instructions and data include all forms of volatile (e.g., random access memory) or non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

The subject matter described herein can be implemented in a computing system that includes a back-end component (e.g., a data server), a middleware component (e.g., an application server), or a front-end component (e.g., a client computer having a graphical user interface or a web browser through which a user can interact with an implementation of the subject matter described herein), or any combination of such back-end, middleware, and front-end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other in a logical sense and typically interact through a communication network. The relationship of client and server may arise by virtue of computer programs running on the respective computers and having a client-server relationship to each other.

A number of implementations of the invention have been described. Nevertheless, it will be understood that various modifications may be made without departing from the spirit and scope of the invention. Accordingly, other embodiments are within the scope of the following claims.

What is claimed is:

1. A method comprising:
generating a system landscape overview of a system landscape including a plurality of systems identified by a unique identifier;
placing a system in a location using a context sensitive menu including information to enable placement within the system landscape overview;
determining a delta path including one or more instructions to install the placed system in the system landscape; and
providing the delta path to enable implementation of the placed system within the system landscape.

2. The method of claim 1, wherein the generating further comprises:
generating, by a landscape generator, a hypertext markup language page of the system landscape overview including metadata representative of the plurality of systems.

3. The method of claim 1, wherein the generating further comprises:
querying at least one of a plurality of data repositories for the metadata including configuration information for the plurality of systems.

4. The method of claim 1, wherein the context sensitive menu includes selections including whether the system is being placed behind, in front of, or parallel with, another system.

5. The method of claim 1, wherein the context sensitive menu is presented within a page depicting the system landscape overview.

6. The method of claim 1, wherein the determining further comprises:
determining information related to other systems in a transport path within the system landscape.

7. The method of claim 6, wherein the information includes at least one release date for the other systems and a required version information for the other systems.

8. A computer-readable storage medium including instructions which when executed by a processor provide operations comprising:
generating a system landscape overview of a system landscape including a plurality of systems identified by a unique identifier;
placing a system in a location using a context sensitive menu including information to enable placement within the system landscape overview;
determining a delta path including one or more instructions to install the placed system in the system landscape; and
providing the delta path to enable implementation of the placed system within the system landscape.

9. The computer-readable storage medium of claim 8, wherein the generating further comprises:
generating, by a landscape generator, a hypertext markup language page of the system landscape overview including metadata representative of the plurality of systems.

10. The computer-readable storage medium of claim 8, wherein the generating further comprises:
querying at least one of a plurality of data repositories for the metadata including configuration information for the plurality of systems.

11. The computer-readable storage medium of claim 8, wherein the context sensitive menu includes selections including whether the system is being placed behind, in front of, or parallel with, another system.

12. The computer-readable storage medium of claim 8, wherein the context sensitive menu is presented within a page depicting the system landscape overview.

13. The computer-readable storage medium of claim 8, wherein the determining further comprises:
determining information related to other systems in a transport path within the system landscape.

14. The computer-readable storage medium of claim 13, wherein the information includes at least one release date for the other systems and a required version information for the other systems.

15. A system comprising:
at least one processor; and
at least one memory including code which when executed by the at least one processor provides operations comprising:
generating a system landscape overview of a system landscape including a plurality of systems identified by a unique identifier;
placing a system in a location using a context sensitive menu including information to enable placement within the system landscape overview;
determining a delta path including one or more instructions to install the placed system in the system landscape; and
providing the delta path to enable implementation of the placed system within the system landscape.

16. The system of claim 15, wherein the generating further comprises:
generating, by a landscape generator, a hypertext markup language page of the system landscape overview including metadata representative of the plurality of systems.

17. The system of claim 15, wherein the generating further comprises:
querying at least one of a plurality of data repositories for the metadata including configuration information for the plurality of systems.

18. The system of claim 15, wherein the context sensitive menu includes selections including whether the system is being placed behind, in front of, or parallel with, another system.

19. The system of claim 15, wherein the context sensitive menu is presented within a page depicting the system landscape overview.

20. The system of claim 15, wherein the determining further comprises:
determining information related to other systems in a transport path within the system landscape.
